(19) United States
(12) Patent Application Publication
(10) Pub. No.: US 2026/0338108 A1
(43) Pub. Date: Oct. 29, 2026

(54) TURBOMACHINE WITH RECOVERED-CYCLE EQUIPPED WITH A HEAT EXCHANGER

(71) Applicant: SAFRAN HELICOPTER ENGINES, Bordes (FR)

(72) Inventors: Jean-Luc BREINING, Moissy-Cramayel (FR); Samuel Christian JOUSSELIN, Moissy-Cramayel (FR); Lois Pierre Denis VIVE, Moissy-Cramayel (FR); Laurent Pierre TARNOWSKI, Moissy-Cramayel (FR); Bernard Claude PONS, Moissy-Cramayel (FR)

(21) Appl. No.: 19/120,179

(22) PCT Filed: Oct. 9, 2023
(86) PCT No.: PCT/FR2023/051567

§ 371 Date: Apr. 10, 2025

(30) Foreign Application Priority Data
Oct. 18, 2022 (FR) FR2210766

(51) Int. Cl. F02C 7/10; F01D 9/06; F01D 25/16; F02C 3/14

(52) U.S. Cl. CPC F02C 7/10; F01D 9/065; F01D 25/162; F02C 3/145; F05D 2240/14; F05D 2260/213

(57) ABSTRACT

The An aircraft turbo machine with a recuperation cycle, including a heat exchanger with a first circuit having an inlet connected to an outlet of a flow path of a turbine and a second circuit with an inlet connected to an air bleed system, and an air outlet, at least one duct for passing services extending from a turbine casing to a beating housing, and an air circulation device including a first channel with a first upstream end connected to the system and a first downstream end connected to the inlet and a second channel having a second downstream end connected to the outlet, and wherein the duct extends radially outwards as far as the device

### TECHNICAL FIELD

This invention relates to the field of aircraft turbomachine with recovered-cycle, in particular comprising a heat exchanger.

### TECHNICAL BACKGROUND

The prior art comprises the documents EP-A2-1589204, GB-A-1084889, FR-A1-3036437, US-A-3339364 and FR-A-1452128.

As shown in FIG. 1, an aircraft turbomachine 10 comprises a gas generator comprising, from upstream to downstream in the direction of gas flow, at least one compressor 2, an annular combustion chamber 3, and at least one turbine 4. The compressor 2 is supplied with air and compresses it. The compressed air is mixed with fuel and burnt in the combustion chamber 3, which supplies combustion gases to the turbine 4. These combustion gases expand in the turbine 4 and drives its rotor 42 in rotation, which in turn drives the compressor 2 rotor via a common shaft.

The turbomachine 10 can be equipped with one or more spools, each comprising a compressor 2 rotor connected by a shaft to a turbine 4 rotor.

There are also turbomachines where a free turbine 4b is mounted downstream of the spool or spools of the turbomachine. A turbine is free as long as its rotor is not connected by a shaft to a compressor rotor.

It is thus understood that a turbomachine may comprise several successive compressors (e.g. a low-pressure compressor followed by a high-pressure compressor), as well as several successive turbines (e.g. a high-pressure turbine followed by a free turbine or a low-pressure turbine).

A turbomachine can be a turboshaft engine (such as helicopter engines, auxiliary power units or APUs) and a turboprop engine (such as aircraft and UAVs).

In the present application, a turbomachine with a conventional cycle is defined as a turbomachine in which the compressed air leaving the compressor(s) supply directly the combustion chamber.

In contrast, a turbomachine with a recovered-cycle (as illustrated in FIG. 1) is a turbomachine in which the combustion gases G flowing out of the turbine(s) 4, 4b are used to heat the compressed air F leaving the compressor(s) 2. The air heated Fc by the gases G is intended to supply the combustion chamber 3. This technology allows to improve the performance of the turbomachine because the amount of fuel required to reach the operating temperature of the turbomachine is less than that required in the scope of a turbomachine with a conventional cycle.

It is therefore advantageous to incorporate a heat exchanger 6 into the structural elements of the turbine 4b to recover the residual energy at the outlet of the turbine 4 and heat the compressed air F upstream of the combustion chamber 3. To this end, with reference to FIG. 2, the exchanger 6 extends radially outside an annular casing 40 of the turbine 4. The exchanger 6 comprises a first circuit 62 connected to an outlet 444 of an annular vein 44 for recovering turbine gases G. The exchanger 6 comprises a second circuit 64 connected to a system 20 (FIG. 1) for collecting compressed air F from the compressor 2 and the air heated Fc by the gases G in the exchanger is transferred upstream to the combustion chamber 3. At least some of the gases G, at the level of the exchanger 6, is released, via an outlet 63, into the atmosphere, notably by passing through an exhaust nozzle of the turbomachine.

One of the disadvantages of integrating this heat exchanger into the turbomachine is its proximity to other elements of the turbine, in particular the auxiliaries. In fact, the turbine comprises auxiliaries S for the operation of the rear bearing(s) of the turbomachine. These auxiliaries cross the annular vein 44 of the turbine. It is not easy to integrate the exchanger 6 in this zone, as it is likely to disturb the exchanges of air F, Fc entering and leaving this exchanger 6.

In this context, it is interesting to overcome the disadvantages of the prior art, by proposing an arrangement of the auxiliaries adapted to the presence of the heat exchanger in a turbomachine with recovered-cycle, so as to limit the pressure losses or efficiency of the air exchanges entering and leaving this heat exchanger while ensuring the auxiliaries functions of the bearing(s).

### SUMMARY OF THE INVENTION

The present invention provides a simple, effective and economical solution to at least some of the above problems.

To this end, the invention proposes an aircraft turbomachine with recovered-cycle, comprising:
at least one compressor centred on an axis X of the turbomachine,
an annular combustion chamber extending around the axis X,
at least one turbine centered on the axis X, this turbine defining an annular vein for gas flow,
an annular enclosure of bearings for guiding at least one rotor of the turbine, this annular enclosure being located radially inside the annular vein,
a heat exchanger located radially outside the annular vein and comprising two circuits, a first circuit of the exchanger comprising an inlet connected to an outlet of the annular vein, and a second circuit of the exchanger comprising an air inlet connected to a collecting system of compressed air from the compressor, and an air outlet,
an annular turbine casing extending around the turbine vein, and
at least one duct of auxiliaries passage which extends radially with respect to the axis X from the turbine casing to the annular enclosure of bearing(s).

According to the invention, the turbomachine further comprises an annular air circulation device extending around the annular vein of the turbine and comprising two coaxial annular channels, a first channel of the device comprising a first upstream end connected to the collecting system and a first downstream end connected to the air inlet of the second circuit of the exchanger and a second channel of the device comprising a second downstream end connected to the air outlet of the second circuit of the exchanger.

According to the invention, said at least one duct extends radially outwards to this annular air circulation device.

Thus, this solution allows to achieve the above-mentioned objective. Thanks to the annular air circulation device, it is possible to minimise pressure losses or air exchange efficiency losses in the second circuit of the exchanger while maintaining the auxiliaries function of the annular enclosure of bearing(s). In addition, the duct or ducts of auxiliaries passage are integrated so as not to disturb the air flow within the first and second channels of the annular air circulation device.

The new configuration of the duct or ducts of auxiliaries passage and the annular air circulation device therefore facilitates exchanges of air F, Fc and gas G between the exchanger and the other components of the turbomachine. To do this, the device of the invention is connected to the second circuit of the exchanger in which, on the one hand, the first channel is configured to supply the exchanger with compressed air F taken from the compressor by the collecting system, and on the other hand, the second channel is configured to redistribute the air Fc heated by the gases G (coming from the first circuit of the exchanger) upstream of the device (in particular upstream of the combustion chamber). At least some of the gases G from the first exchanger circuit are configured to leave the exchanger, in particular outside the turbomachine, for example via an exhaust nozzle of the turbomachine.

The invention therefore has the advantage of offering a simple design that is highly reliable and has little impact in terms of cost and space requirements in the turbomachine.

The guide element according to the invention may comprise one or more of the following characteristics, taken in isolation from each other or in comparison with each other:
said at least one duct comprises a radially outer end which comprises a connecting end-piece, and which is connected to the annular air circulation device for example by an annular linear connection ;
at least one seal is housed in a groove of the radially outer end;
said at least one duct passes through a radial opening or orifice in the annular air circulation device, this opening or orifice extending radially over the entire thickness of said device;
the first and second channels of the annular air circulation device diverge downstream and each comprise a passage cross-section which increases from their upstream axial ends to their downstream axial ends;
the annular air circulation device comprises three coaxial annular walls defining between them said first and second channels, each of these walls comprising a fastening flange or a sealing member at each of its axial ends;
the annular air circulation device has an external diameter DE₈ at its upstream end which lies between internal DI₈₄₄ and outer DE₈₂₄ diameters of its downstream end, and which lies for example between diameters D₈₇, D₈₅ of the downstream ends of its partition and internal walls;
the annular turbine casing comprises at least one passage orifice of said at least one duct;
said at least one duct of auxiliaries passage has a radial dimension H₇ of between 110 and 170 mm, preferably the radial dimension H₇ is between 150 and 160 mm;
said at least one duct of auxiliaries passage has an external diameter DE₇ of between 6 and 10 mm and an internal diameter DI₇ of between 4 and 8 mm.

The invention also relates to an aircraft comprising at least one turbomachine with recovered-cycle according to one of the characteristics of the invention.

### DESCRIPTION OF THE FIGURES

The invention will be better understood and other details, characteristics and advantages of the present invention will become clearer from the following description made by way of non-limiting example and with reference to the attached drawings, in which:

FIG. 1 is a schematic axial sectional view of a turbomachine with recovered-cycle in the prior art,

FIG. 2 is an enlarged schematic view in partial acial section of the ducts of auxiliaries passage and a heat exchanger in the turbomachine of FIG. 1,

FIG. 3 is a schematic axial sectional view of a turbomachine with recovered-cycle according to the invention,

FIG. 4 is a schematic axial cross-sectional view of ducts of auxiliaries passage of the turbomachine of FIG. 3,

FIG. 5 is a schematic perspective view of an annular air circulation device of the turbomachine of FIG. 3 according to a first embodiment,

FIG. 6 is an enlarged schematic view in partial axial section of the turbomachine shown in FIG. 3, comprising the ducts of auxiliaries passage shown in FIG. 4 arranged with the annular air circulation device shown in FIG. 5,

FIG. 7 is a schematic perspective view of an annular air circulation device of the turbomachine of FIG. 3 according to a second embodiment,

FIG. 8 is an enlarged schematic view in partial axial section of the turbomachine in FIG. 3, comprising the ducts of auxiliaries passage of FIG. 4 arranged in the annular air circulation device of FIG. 7.

The elements with the same functions in the different implementations have the same references in the figures.

### DETAILED DESCRIPTION

By convention, in the following description, the terms “longitudinal” and “axial” refer to the orientation of structural elements extending in the direction of a longitudinal axis, such as a longitudinal axis of the engine of a turbomachine. The terms “radial” or “vertical” refer to an orientation of structural elements extending along a direction perpendicular to the longitudinal axis. The terms “inner” and “outer”, and “internal” and “external” are used in reference to a positioning with respect to the longitudinal axis. Thus, a structural element extending along the longitudinal axis comprises an inner face facing the longitudinal axis and an outer surface opposite its inner surface.

Similarly, by convention in this application, the terms “upstream” and “downstream” are defined in relation to the direction of gas flow in the turbomachine.

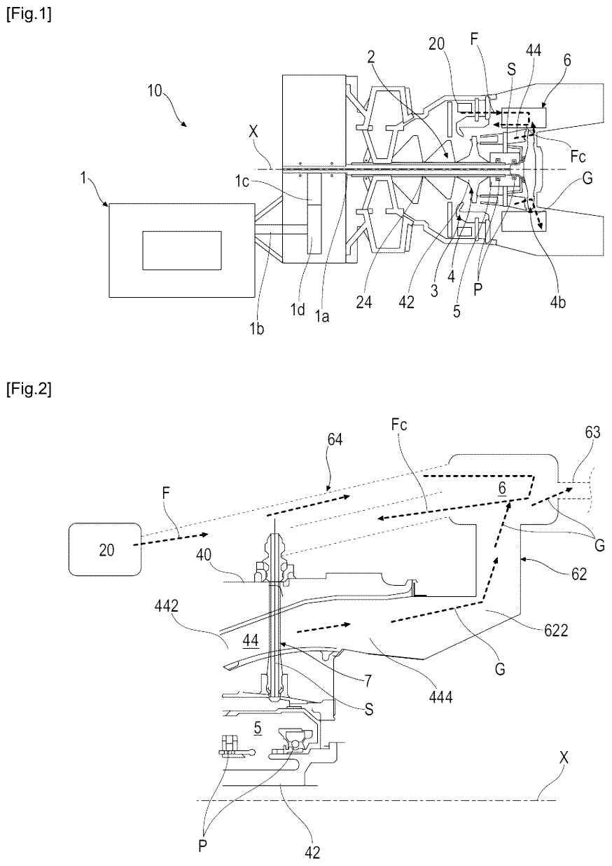

FIGS. 1 and 2 have been described above and illustrate a prior art turbomachine 10 with a recovered-cycle, in which the duct or ducts 7 of auxiliaries S passage pass through, on the one hand, the annular vein 44 supplying the turbine 4b and, on the other hand, the second circuit 64 of the heat exchanger 6.

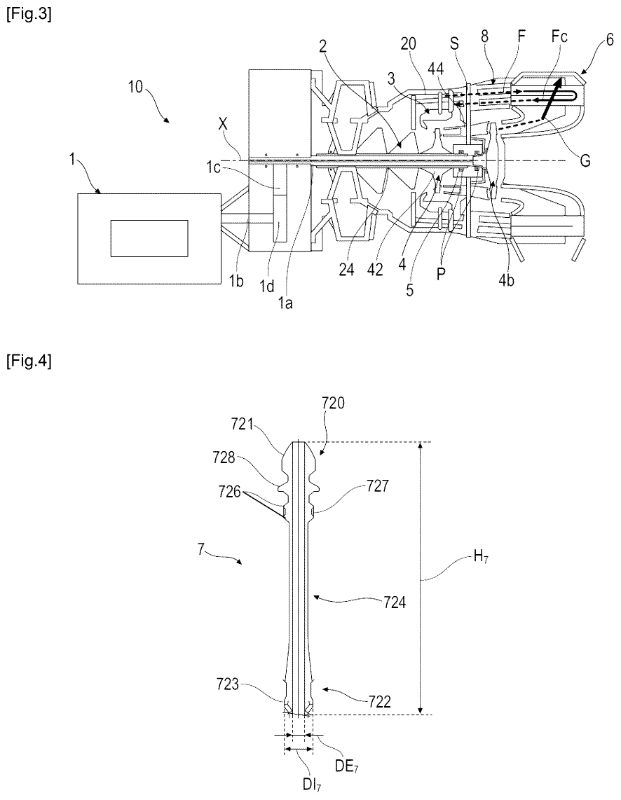

The invention applies to an aircraft turbomachine 10 with recovered-cycle. A non-limiting example of a turbomachine 10 is shown in FIG. 3 as a turboshaft engine.

The turbomachine 10 extends along a longitudinal axis X. The turbomachine 10 comprises at least one compressor 2 (for example a high-pressure compressor in FIG. 3), an annular combustion chamber 3 and at least one turbine 4, 4b (for example a high-pressure turbine 4 and a free turbine 4b in FIG. 3).

The compressor 2 and the turbine 4 can be ring-shaped. The compressor 2 and turbine 4 are centred on the axis X of the turbomachine. The combustion chamber 3 extends around the axis X. The compressor 2 comprises a collecting system 20 of compressed air F (for example via a compressed air collecting duct or cavity F at the outlet of the compressor 2).

The turbomachine 10 may include a speed reduction gear 1.

In the example shown in FIG. 3, the compressor 2 is connected to the turbine 4 by a drive shaft 24. The free turbine 4b drives a power shaft 1b via a through transmission shaft 1a and the power shaft 1. The through shafts 1a and power shaft 1b are engaged with the reduction gear 1 via pinions 1c, 1d.

The turbine 4 comprises an annular turbine casing 40, at least one rotor 42 and an annular vein for gas flow 44. The rotor(s) 42 may extend around the drive shaft 24. The annular casing 40 extends around the annular vein 44. The annular vein 44 can extend between the annular casing 40 and the rotor 42.

The annular vein 44 comprises an inlet 442 in particular for gases G from the combustion chamber 3, and an outlet 444 for gases G in particular in direction of a heat exchanger 6 (described below).

The turbomachine 10 comprises an annular enclosure 5 with one or more bearings P for guiding the rotor or rotors 42. This annular enclosure 5 is located radially inside the annular vein 44.

The turbomachine 10 comprises at least one or more duct(s) 7 of auxiliaries S passage. The duct or ducts 7 extend(s) radially with respect to the axis X from the annular enclosure 5 of the bearing(s) (P) to the turbine casing 40 (FIG. 6).

FIG. 4 shows an example of this duct 7. The duct 7 may extend between a radially outer end 720 and a radially internal end 722 (for example, relative to the axis X). This radially outer end 720 may comprise a first connecting end-piece 721. This first connecting end-piece 721 can be configured to attach to a fluid supply pipe for the auxiliaries(S) and external to the turbine 4 (not shown). To this end, the first connecting end-piece 721 may comprise a thread for connection to the supply pipe. The radially internal end 722 may comprise a second connecting end-piece 723 which is configured to be secured to the annular enclosure 5. To this end, the second connecting end-piece 723 may comprise a thread for connection to the annular enclosure 5.

The duct 7 may comprise a middle portion 724 which connects the radially external 720 and internal 722 ends.

The first connecting end-piece 721 may comprise shoulders 726. FIG. 4 illustrates two shoulders 726 at the first connecting end-piece 721. One or more grooves 727 may be formed between the shoulders 726. The first connecting end-piece 721 may also comprise a collar 728 which extends radially outwards from the shoulders 726.

The duct 7 may have a radial dimension H₇. The duct 7 can have a first external diameter DE₇ and a first internal diameter DI₇.

The turbomachine 10 comprises a heat exchanger 6. This exchanger 6 is located radially outside the annular vein 44.

The exchanger 6 comprises two circuits, a first circuit 62 and a second circuit 64.

The first circuit 62 comprises an inlet 622 connected to the outlet 444 of the annular vein 44. The first circuit 62 is configured to supply the exchanger 6 with gas G.

The first circuit 62 may also comprise an outlet 632 allowing at least some of the gases G to leave the exchanger 6 towards the outside of the turbomachine. For example, the gas G may exit via an exhaust nozzle of the turbomachine, in which case the outlet 632 of the gas G is connected to the exhaust nozzle.

The second circuit 64 comprises an air inlet 642 connected to the collecting system 20 F of compressed air in the compressor 2, and an air outlet 644. The second circuit 64 is configured firstly to supply the exchanger 6 with a flux of compressed air F from the collecting system 20, and secondly to transfer a flux of air Fc heated by the gases G in the exchanger 6, in particular upstream of the combustion chamber 3. The compressed air flux F is thus heated by at least some of the gases G from the first circuit 62 to form the heated air flux Fc.

One of the special characteristics of the invention is that the turbomachine 10 also comprises an annular air circulation device 8.

FIGS. 4 to 8 illustrate a number of different embodiments for the annular air circulation device 8 within the turbomachine 10.

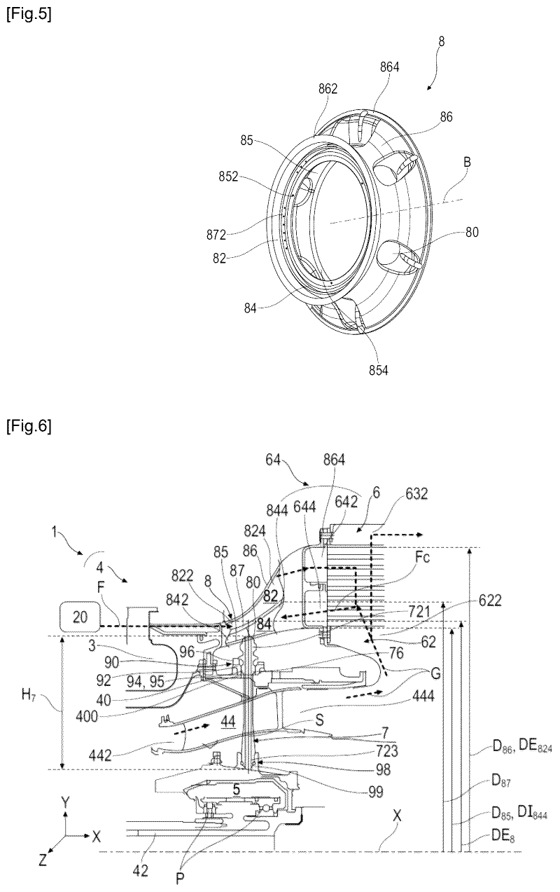

With reference to FIGS. 5 and 6, a first embodiment of the annular air circulation device 8 will now be described.

The device 8 may be an annular part of revolution extending around a longitudinal axis B. This axis B is substantially parallel (or inclined, for example, at an angle of between 5 and 45° to the axis X in FIG. 6) with respect to the axis X.

The device 8 comprises two coaxial annular channels: a first channel 82 and a second channel 84.

The first channel 82 may extend between a first upstream axial end 822 and a first downstream axial end 824. In particular, the first channel 82 is in fluid communication with the inlet 642 and the collecting system 20 so that the exchanger 6 can be supplied with compressed air flux F.

The second channel 84 may extend between a second downstream axial end 844 and a second upstream axial end 842. In particular, the second channel 84 is in fluid communication with the air outlet 644 and the upstream side of the combustion chamber 3 in order to be able to redistribute the flux of heated air Fc from the exchanger 6 to the upstream side of the combustion chamber 3.

The first and second channels 82, 84 can diverge downstream, and each comprise a passage section which increases from their upstream axial ends 822, 842 to their downstream axial ends 824, 844.

The device 8 comprises three coaxial annular walls, respectively an internal annular wall 85, an external annular wall 86 and a partition wall 87. This partition wall 87 extends between the internal wall 85 and the external wall 86.

The external wall 86 and the partition wall 87 define the first channel 82 between them. The internal wall 85 and the partition wall 87 define the second channel 84 between them.

In the example shown in FIG. 5, the three annular walls 85, 86, 87 and the two channels 82, 84 are in single part (i.e. made of the same material).

The internal wall 85 may comprise a first fastening flange 852, in particular at its upstream axial end, and/or a second fastening flange 854, in particular at its downstream axial end. Alternatively (not illustrated), the internal wall 85 may comprise a first sealing member on its upstream axial end and/or its downstream axial end. For example, this first sealing member may be a flange fixed with or without a seal.

The external wall 86 may comprise a third fastening flange 862, in particular at its upstream axial end, and/or a fourth fastening flange 864, in particular at its downstream axial end. Alternatively (not shown), the external wall 86 may comprise a second sealing member on its upstream axial end and/or its downstream axial end. For example, this second sealing member can be a rim fixed with or without a seal.

The partition wall 87 may comprise a third sealing member 872, in particular on its upstream axial end, and/or a fourth sealing member 874, in particular on its downstream axial end. For example, these third and fourth sealing members can be a rim fixed with or without a seal. Alternatively (not illustrated), the partition wall 87 may comprise a fastening flange on its upstream axial end and/or its downstream axial end.

The internal, external and partition walls 85, 86 and 87 may have a first diameter D₈₅, a second diameter D₈₆ and a third diameter D₈₇ respectively at their downstream ends.

As shown in FIG. 6, the device 8 may have a second external diameter DE₈ at its upstream end. This second external diameter DE₈ can be between the first diameter D₈₅ and the third diameter D₈₇. The device 8 can have a third external diameter DE₈₂₄ and a second internal diameter DI₈₄₄ at its downstream end. The second external diameter DE₈ can be between the third external diameter DE₈₂₄ and the second internal diameter DI₈₄₄.

In the example shown in FIG. 6, the first diameter D₈₅ is substantially identical to the internal diameter DI₈₄₄ and the second diameter D₈₆ is substantially identical to the external diameter DE₈₂₄.

The device 8 may comprise one or more openings 80 (or orifices 81) which extend radially through the entire thickness of the device 8. The thickness of the device 8 is measured in a plane perpendicular to the axis B (or axis X).

We will now describe the annular air circulation device 8 of the first embodiment assembled in the turbomachine 10, with reference to FIG. 6. In the turbomachine 10, the device 8 extends around the annular vein 44, in particular around the annular turbine casing 40.

The first upstream axial end 822 of the first channel 82 of the device 8 is connected to the collecting system 20, and the first downstream axial end 824 is connected to the air inlet 642 of the second circuit 64 of the exchanger 6. The second downstream axial end 844 of the second channel 84 of the device 8 is connected to the air outlet 644 of the second circuit 64 of the exchanger 6. The second upstream axial end 842 may open downstream of the combustion chamber 3.

Another characteristic of the invention is that the duct or ducts 7 extend radially outwards (with respect to the axis X) as far as the annular air circulation device 8.

In the example assembly shown in FIG. 6, the duct 7 extends from the annular enclosure 5 to the device 8. In particular, the first connecting end-piece 721 of the duct 7 extends into the opening 80 of the device 8 (at the level of the internal wall 85), and the second connecting end-piece 723 extends into the annular enclosure 5. The middle portion 724 of the duct 7 passes through the annular vein 44.

The annular casing 40 may include at least one passage orifice 400 of the duct 7. This passage orifice 400 may be substantially aligned with opening 80 in a plane perpendicular to the axis X.

According to the assembly shown in FIG. 6, the duct 7 is connected to the annular enclosure 5, for example by a screw connection 98 with a thread formed on the radially internal end 722.

The duct 7, in particular the radially outer end 720, may be in contact with the annular casing 40 by means of an annular linear connection 90, for example. In particular, the radially outer end 720 comprises two bearing surfaces (such as at the shoulders 726 and the collar 728) to produce this annular linear connection.

An “annular linear connection” is defined as a connection between a spherical piece (i.e. the two bearing surfaces at the shoulders 726 and the collar 728 of the radially outer end 720) and a cylindrical piece (i.e. the annular casing 40 at the passage orifice 400).

In this way, the annular linear connection can allow the radially outer end 720 of the duct 7 to translate relative to the passage orifice 400 along an axis Y, and/or to flex along the axis X and a circumferential axis Z while remaining guided in the passage orifice 400. The axis Y can be substantially perpendicular to the axis X. The axis Z can be substantially transverse to the axis X.

At the second connecting end-piece 723, a conical seal 99 can be arranged to provide a seal with the annular enclosure 5. In the area of the shoulders 726, two segment seals 94, 95 can be arranged to provide a seal with the annular casing 40. These seals 94, 95 can be located in the grooves 727. At the collar 728, the duct 7 can be locked against rotation with a splined flange 96 allowing the duct 7 to slide on the collar 728 (also splined). A bushing 92 (which may be a wear part) can be assembled on a bearing surface at the seals 94, 95.

The screw connection 98 and the annular linear link 90 allow the duct or ducts 7 to expand freely in the turbomachine.

The first connecting end-piece 721 may comprise a thread for fixing the duct 7 to the external supply pipe, allowing the continuity of the duct 7 of auxiliaries S passage. In the example shown in FIG. 6, the external supply pipe is configured to pass through the aperture 80 to be fixed to the first connecting end-piece 721 located at the opening 80 of the device 8.

At the first connecting end-piece 721, a gasket can be fitted to allow the entire duct 7 of auxiliaries passage to be sealed.

The radial dimension H₇ of the duct 7 of auxiliaries S passage is between 110 and 170 mm. In particular, the radial dimension H₇ in FIG. 6 is between 110 and 120 mm.

The first external diameter DE₇ of duct 7 may be between 6 and 10 mm. Preferably, the first external diameter DE₇ is between 8 and 9 mm. The first internal diameter DI₇ of duct 7 may be between 4 and 8 mm. Preferably, the first internal diameter DI₇ is 6 mm.

In the assembly of the duct or ducts 7 and the device 8 of the first embodiment (FIG. 6), the compressed air F (from compressor 2) is drawn off by the collecting system 20 and conveyed to the exchanger 6 via the first channel 82 of the device 8.

The combustion gases G (leaving the combustion chamber 3 and turbine 4) flow into the annular vein 44 and are conveyed to the exchanger 6 by the first circuit 62. At least some of the gases G are used to heat the compressed air F in the exchanger 6. The air Fc heated by the gases G is then conveyed through the second channel 84 of the device 8, in particular upstream of the combustion chamber 3. Another part of the G gases can be evacuated from the turbomachine.

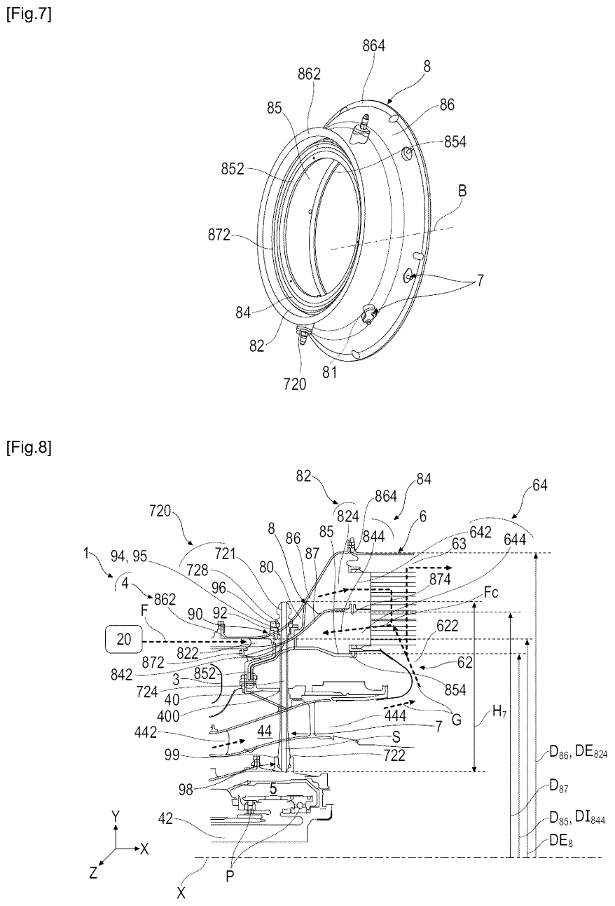

FIGS. 7 and 8 illustrate a second embodiment of the annular air circulation device 8 assembled in the turbomachine 10 according to the invention.

The device 8 of the second embodiment differs from the device 8 of the first embodiment in that the first connecting end-piece 721 of the duct 7 is fixed to the device 8 (instead of being fixed to the annular casing 40 of FIG. 6).

To achieve this, the annular linear connection 90 (which may comprise the splined flange 96 and segmental seals 94, 95) may be located in the device 8.

In particular, the annular linear connection 90 is located at the level of the outer wall 86 and/or the first channel 82 of the device 8.

In the example shown in FIG. 8, at least part of the radically outer end 720 passes through the orifice 81, and the annular linear connection 90 is located at the level of the outer wall 86 and the first channel 81. The first connecting end-piece 721 extends at least partly outwards from the outer wall 86. This allows to connect to the external supply pipe, and does not disturb the air exchanges F, Fc of the second circuit 64 of the exchanger 6. In addition, the duct 7 of the second embodiment differs from that of the first embodiment in radial dimension H₇. The radial dimension H₇ of the duct 7 in the second embodiment may be between 140 and 160 mm. In addition, the median portion 724 of the duct 7 passes at least in part through the annular vein 44 and the annular casing 40, and the radially outer end 720 passes at least in part through the first and second channels 82, 84 in the example shown in FIG. 7.

Enlarging the radial dimension H₇ of the duct in the second embodiment enables the first connecting end-piece 721 to be positioned radially furthest outwards from the device 8. This allows to assemble this first connecting end-piece 721 with the supply pipe external to the turbine 4, and further reduces the blockage that can be produced by the passage of the duct or ducts 7 through the first and second channels 82, 84 and the annular vein 44. In this way, the exchange of air F, Fc between the device 8 and the second circuit 64 of the exchanger is more efficient.

1. An aircraft turbomachine with a recovered-cycle, comprising:
at least one compressor centered on an axis of the turbomachine,
an annular combustion chamber extending around the axis,
at least one turbine centered on the axis this turbine defining an annular vein for gas flow,
an annular enclosure of bearing(s) for guiding at least one rotor of the turbine, this annular enclosure being located radially inside the annular vein,
a heat exchanger located radially outside the annular vein and comprising two circuits, a first circuit of the exchanger comprising an inlet connected to an outlet of the annular vein, and a second circuit of the exchanger comprising an air inlet connected to a collecting system of compressed air from the compressor, and an air outlet
an annular turbine casing extending around the annular vein, and
at least one duct of auxiliaries passage which extends radially with respect to the axis from the turbine casing to the annular enclosure of bearing(s),
wherein the turbomachine further comprises an annular air circulation device extending around the annular vein of the turbine and comprising two coaxial annular channels, a first channel of the device comprising a first upstream axial end connected to the collecting system and a first downstream axial end connected to the air inlet of the second circuit of the exchanger, and a second channel of the device comprising a second downstream axial end connected to the air outlet of the second circuit of the exchanger,
and in that said at least one duct extends radially outwards to said annular air circulation device,
and in that said at least one duct comprises a radially outer end which comprises a connecting end-piece and which is connected to the annular air circulation device.

2. The turbomachine according to claim 1, wherein said radially outer end is connected to the annular air circulation device by an annular linear link.

3. The turbomachine according to claim 2, wherein at least one seal, is housed in a groove of the radially outer end.

4. The turbomachine according to claim 1, wherein said at least one duct passes through a radial opening or orifice of the annular air circulation device this opening or this orifice extending radially over the entire thickness of said device.

5. The turbomachine according to claim 1, wherein the first and second channels of the annular air circulation device diverge downstream and each comprise a passage cross-section which increases from their upstream axial ends to their downstream axial ends.

6. The turbomachine according to claim 1, wherein the annular air circulation device comprises three coaxial annular walls, defining between them said first and second channels each of these walls, comprising a fastening flange or a sealing member, at each of its axial ends,

7. The turbomachine according to claim 6, wherein the annular air circulation device has an external diameter (DE₈) at its upstream end which lies between inner (DI₈₄₄) and outer (DE₈₂₄) diameters of its downstream end, and which lies for example between diameters (D₈₇, D₈₅) of the downstream ends of its partition and internal walls.

8. The turbomachine according to claim 1, wherein the annular turbine casing comprises at least one passage orifice of said at least one duct.

9. The turbomachine according to claim 1, wherein said at least one duct of auxiliaries passage has a radial dimension (H₇) of between 110 and 170 mm, preferably the radial dimension (H₇) is between 150 and 160 mm.

10. The turbomachine according to claim 1, wherein said at least one duct of auxiliaries passage has an external diameter (DE₇) of between 6 and 10 mm and an internal diameter (DI₇) of between 4 and 8 mm.
